(19) United States
(12) Patent Application Publication
(10) Pub. No.: US 2014/0034227 A1
(43) Pub. Date: Feb. 6, 2014

(54) Adhesive retrieval tab for removal of credit card style item

(71) Applicants: Julia Segui, Altamonte Springs, FL (US); Valerie Saez, Altamonte Springs, FL (US)

(72) Inventors: Julia Segui, Altamonte Springs, FL (US); Valerie Saez, Altamonte Springs, FL (US)

(21) Appl. No.: 13/987,087

(22) Filed: Jul. 1, 2013

Related U.S. Application Data
(60) Provisional application No. 61/742,114, filed on Aug. 3, 2012.

(51) Int. Cl. B65C 1/04; G09F 3/10

(52) U.S. Cl. CPC B65C 1/04; G09F 3/10
USPC 156/249; 428/41.8

(57) ABSTRACT

Adhesive retrieval tab allows for easy removal of any credit card style item from wallet slots and from any cardholder

An adhesive retrieval tab that aids in identification and removal of any credit card style item. The adhesive retrieval tab is comprised of an adhesive strip, symbolically divided into four sections, whereby the two center sections, when folded to meet, form the tab portion that extends beyond the edge of credit card style item. Center section may also contain an optional insert.

The outer two sections having adhesive-resistant peel-off sheets whereby when removed allows adherence to the front and back of credit card style items. Adhesive retrieval tab can be clear, of any color, shape, design, and pattern.

### BACKGROUND-PRIOR ART

The following is a prior art reference that presently appears relevant.

### US Patent Application Publication

| Publication number | Kind Code | Publ. Date | Patentee |
|---|---|---|---|
| 20100139138 | A1 | 2010-06-10 | Miadich |

Most people carry a variety of credit card style items in their wallets, cardholders, and other card-carrying cases. Examples include, but are not limited to, Driver's license, Photo ID cards, membership cards, hotel key cards, cards for gated community access . . . etcetera. Credit card style items can be difficult to remove from tight wallet slots. Credit card style items may also be hard to identify since they are not completely visible from wallet and cardholder slots. Furthermore, many men carry a pouch-like cardholder in their pockets, and find they have to remove all the cards to find the desired one.

Another type of card retrieval tool proposed is the one by Miadich, John B. patent application number 20100139138.

Thus, disadvantages of the heretofore type involve a far more complex design, with complex components, such as, hinges, rigid metal, extension tools, . . . etcetera. Also involves manufacturing by metal injection molding, all of which results in higher manufacturing cost due to more expensive materials. Add to this, increased shipping cost. Further, plastic materials have the potential to be damaged, for example cracking, especially since most men carry their wallets in their back pockets.

Additionally, they contain extension parts that are more complicated for the consumer to use. They also can create excess bulk in wallets and cardholders, and contain detachable components that may be easy to lose.

Therefore, a better solution would be a product that is simplified. One made of an adhesive strip that is flexible as well as having a sleek design, with practical and easy use for the consumer.

### SUMMARY

In accordance with one embodiment an adhesive retrieval tab, with optional insert for the tab portion that extends beyond the edge of any credit card style item. An adhesive retrieval tab having variable bond strengths comprises an adhesive strip, optional insert, and a plurality of adhesive-resistant peel-off sheets.

### ADVANTAGES

Accordingly, several advantages of one or more aspects are as follows: Inexpensive to manufacture, making it affordable enough for consumers to buy, lighter in weight than prior art reference resulting in less shipping costs, simplicity of use, practical for ease of removal of credit card style items, also allows for quick identification in selection of credit card style items, can be clear, can also be manufactured with designs, colors, shapes, and patterns all of which can be customized to the user's preference. For example, customized messages can be printed on the adhesive strip itself both horizontally as well as vertically. Messages can also be printed on optional inserts both horizontally as well as vertically.

Samples of messages can include, but are not limited to, “Thank-you”, “I Love You”, “Congratulations”, “Happy Anniversary”, “It's a girl)”, “It's a boy!”, . . . etcetera.

Additionally, the slim sleek flexible design of the product results in no unnecessary bulk in the user's wallet, especially for men's wallets, which are usually carried in their back pockets. The magnetic strip on the credit card style item can still be swiped with the adhesive retrieval tab attached. Adhesive retrieval tab has one basic style that will accommodate all credit card style items regardless of card thickness, example credit card versus business card, hotel card key versus photos . . . etcetera. Affordability to the consumer allows for frequent change-out if desired, example-seasonal designs, holiday designs, sports team designs and others. Can serve for temporary as well as permanent use. This is an advantage to businesses as an additional method of advertising as well as distinguishing their card from other business cards simply at the opening of a wallet. Other advantages of one or more aspects will be apparent from a consideration of the drawings and ensuing description.

### DRAWINGS—FIGURES

In the drawings, closely related figures have the same number but different alphabetic suffixes.

FIG. 1 shows adhesive retrieval tab assembled.

FIG. 2 shows entire adhesive strip prior to assembly symbolically divided into four sections, with adhesive-resistant peel-off sheets on opposite ends.

FIGS. 3A and 3B shows a side view of the entire adhesive strip being folded in half, one without optional insert, and one with optional insert.

FIG. 4 shows adhesive retrieval tab assembled with peel-off sheet being removed to adhere to credit card style item.

FIGS. 5A to 5C shows front and back bottom portions of tab being adhered to credit card style item.

FIG. 6 shows wallet display of credit card style items with adhesive retrieval tabs adhered.

### DRAWINGS—REFERENCE NUMERALS

| | | | |
|---|---|---|---|
| 10 | center left of adhesive strip | 12 | center right of adhesive strip |
| 14 | outer right of adhesive strip | 16 | outer left of adhesive strip |
| 18 | optional insert | 20 | peel-off sheet |
| 22 | peel-off sheet | | |

### DETAILED DESCRIPTION

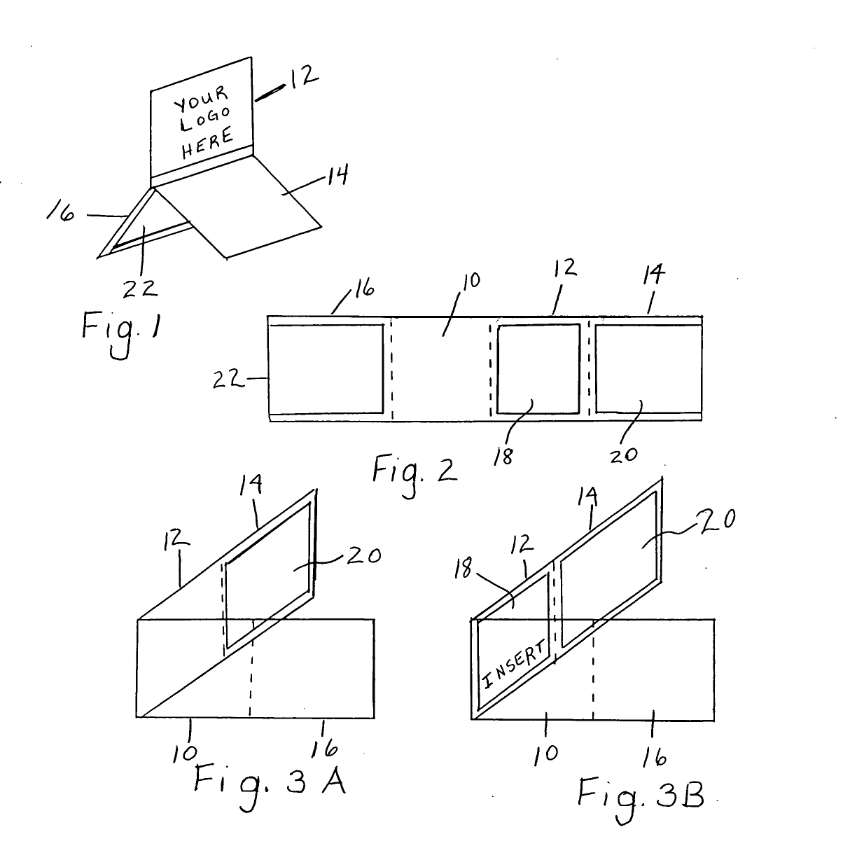

One embodiment of the completed adhesive retrieval tab FIG. 1 is an adhesive strip of sufficient size. However, each adhesive strip can be of varying bond strength, can be smooth, and can also be textured. As shown in FIG. 2, the adhesive strip is symbolically divided into four sections, section 10, section 12, section 14, and section 16. An adhesive-resistant peel-off sheet 20 is placed on outer right section 14 of the adhesive strip. Also, an adhesive-resistant peel-off sheet 22 is placed on outer left section 16 of the adhesive strip.

Another embodiment is that either center section, section 10, section 12, can contain optional insert 18. Optional inserts can be made of various materials, such as, but not limited to, paper, film, cardboard, vinyl, . . . etcetera.

Another embodiment is that the adhesive strip will then be folded over in half FIG. 3A and FIG. 3B, with section 10 and section 12 meeting to form the portion of the tab that extends beyond the edge of the credit card style item as a gripping portion. In other embodiments, the gripping portion thus becomes flexible as a result of the aforementioned softer materials, whereas the gripping portion becomes firmer as a result of harder aforementioned materials. This is also referred to as the top portion of the adhesive retrieval tab as shown in FIG. 1 assembled.

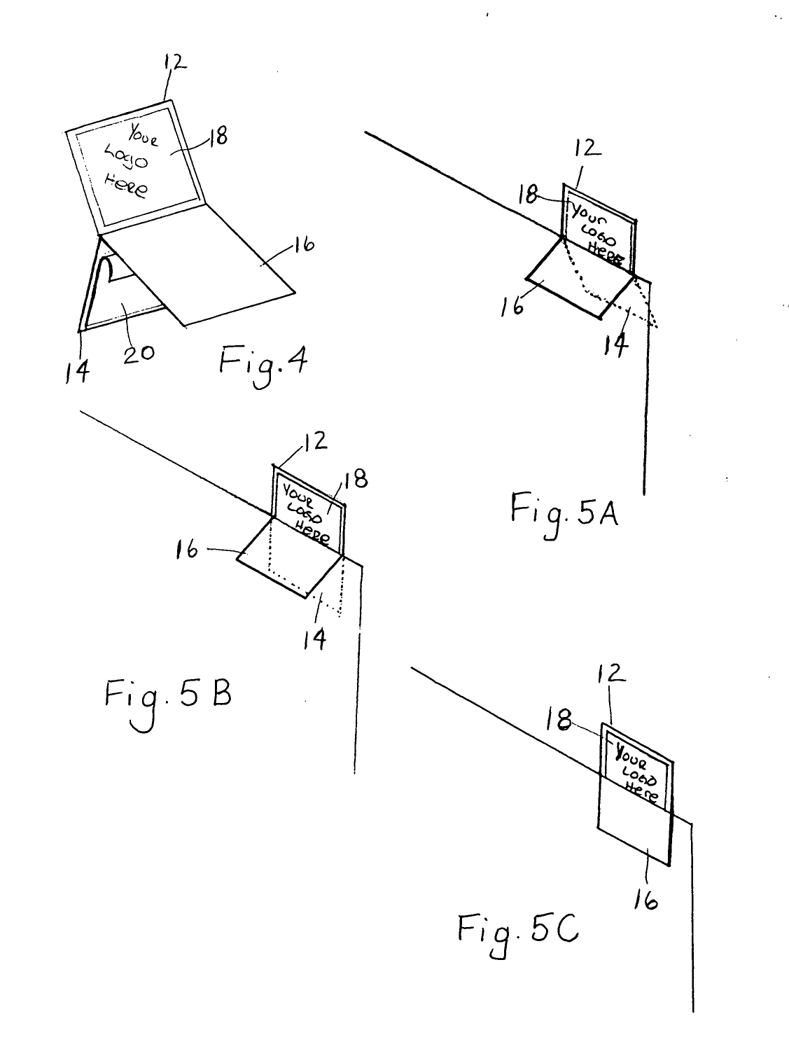

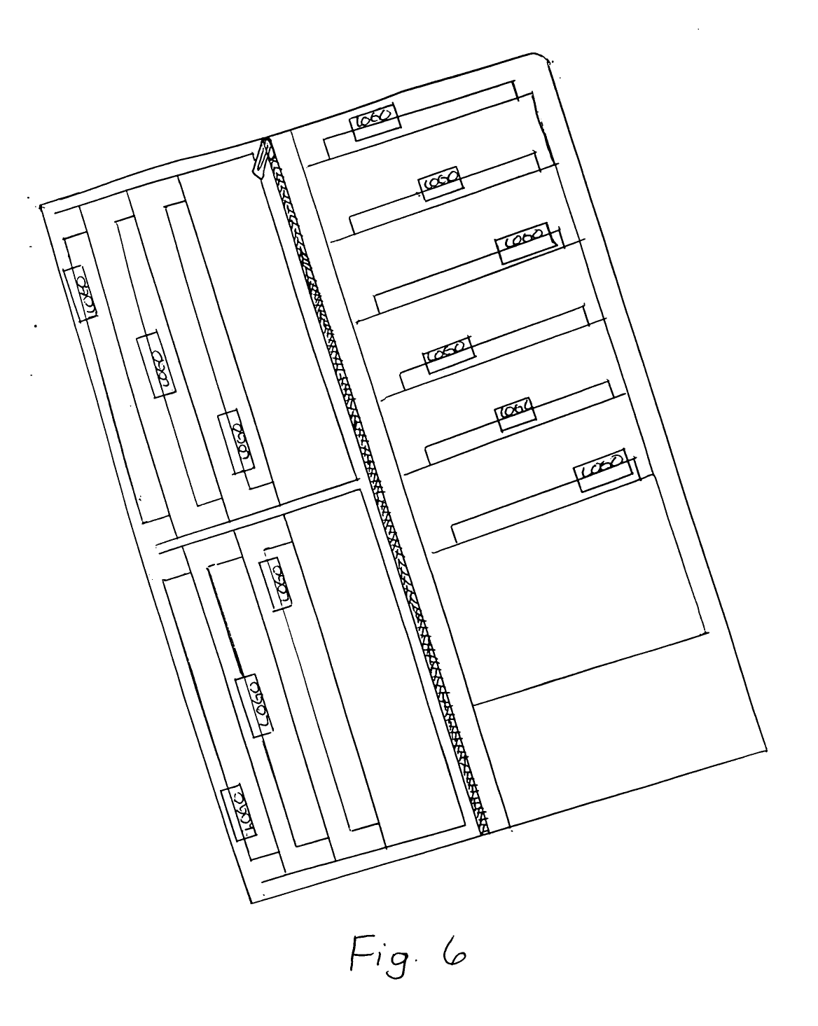

As shown in FIG. 4, adhesive-resistant sheets can be peeled off to adhere the adhesive retrieval tab to the credit card style item. Each bottom portion of the adhesive retrieval tab would then be adhered to back side FIG. 5B and front side FIG. 5C of credit card style item. In FIG. 6, the wallet view clearly shows the ease with which any credit card style item can be identified as well as retrieved conveniently.

### ADDITIONAL EMBODIMENTS

Additional embodiments are shown in FIGS. 1 and 4; In each case top tab portion can serve to advertise things such as, but not limited to, logos, trademarks, company names, . . . etcetera. Top portion can also be customized personalized with things such as, but not limited to, initials, photos, phrases, messages, . . . etcetera.

Further the adhesive strip itself FIG. 2 has options such as, but not limited to, being clear, colored, patterned or designed. Printing can be done on optional insert, as well as directly onto adhesive strip itself.

### CONCLUSION, SCOPE

Accordingly it can be seen that the adhesive retrieval tab of various embodiments can be used to easily retrieve credit card style items from wallet slots and cardholders. It can also be used for quick and convenient identification of credit card style items. The low cost allows for mass production for the manufacturer. Manufacturer can also offer customized and personalized options to the consumer. Companies also have the ability to advertise their logos on these adhesive retrieval tabs

Although the description above contains many specificities, these should not be construed as limiting the scope of the embodiments but as merely providing illustrations of some of several embodiments. For example, the tabs can have other shapes, such as circles, triangles, rectangle . . . etcetera; the adhesive bond strength can be weaker or stronger . . . etcetera.

Thus, the scope of the embodiments should be determined by the appended claims and their legal equivalents, rather than by examples given.

We claim:

1. An adhesive retrieval tab of sufficient size as a means of easy removal as well as identification of any credit card style item from wallet slots and card carrying cases comprising an adhesive strip, whereby the center section of said adhesive strip serves as a tab, with optional insert, to extend beyond the edge of said credit card style item, and the outer sections of said adhesive strip having adhesive-resistant peel-off sheets.

2. Said adhesive strip can have varying bond strengths.

3. An adhesive strip, textured, smooth, clear, of any color, design shape, pattern, of sufficient size element means, one outer section to be adhered to the front of said credit card style item, and the other outer section to be adhered to the back of said credit card style item so as to grip said item for easy retrieval.

4. Said center sections of said adhesive strip when folded over to meet serve as tab portion extending beyond the edge of said credit card style item for gripping.

5. Said center section of adhesive retrieval tab element, clear, of any color, shape, design, pattern element means that will enable said adhesive strip element to be visible from wallet slots, whereby quick and easy identification and removal of said card item will occur conveniently.

6. Said center section inserts may include flexible as well as firm materials.

7. A plurality of adhesive-resistant peel-off sheet elements.

8. Said peel-off sheet elements having means for removal from outer sections of said adhesive strip element, whereby said adhesive strips can be adhered to any side of said credit card style item.

9. A method of adhering adhesive retrieval tab to any credit card style item comprising;
a. Holding said adhesive tab from the top portion, so that the plurality of adhesive-resistant peel-off sheets can be removed,
b. Removing front and back bottom portions of said adhesive-resistant peel-off sheets respectively, whereby adhesive strips can be adhered to the front and back sides of said credit card style item.
